(19) United States
(12) Patent Application Publication
(10) Pub. No.: US 2012/0061371 A1
(43) Pub. Date: Mar. 15, 2012

(54) Electrically intercoupled glove and ski pole

(76) Inventor: Molly B. Broom, Towson, MD (US)

(21) Appl. No.: 12/923,818

(22) Filed: Oct. 8, 2010

Related U.S. Application Data
(60) Provisional application No. 61/344,685, filed on Sep. 10, 2010.

(51) Int. Cl. H05B 3/02; A41D 19/015; A63C 11/22

(52) U.S. Cl. 219/211; 280/821; 2/161.1

(57) ABSTRACT

A system and method for actively warming outerwear of a skiier, in particular through the gloved hand of a skier. Ski racers who require a protective, lightweight and sleek glove suitable for coming into contact at high speed with the plastic gates typically used on race courses. The present invention comprises an electrically-couplable ski pole and glove/strap. In disclosed embodiments, the ski pole contains a battery power source (preferably rechargeable) which connects electrically to a heating element sewn into a mating glove, e.g., via a releasable strap integrated into the glove. The invention eliminates the bulk and weight of an in-glove chemical pack or self-contained battery heating systems, where the heat pack or power source is integrated into the glove.

The present application claims priority from U.S. Provisional No. 61/344,685, filed Sep. 10, 2010, entitled “Electrically Intercoupled Glove and Ski Pole,” to Broom, the entirety of which is explicitly incorporated herein by reference.

### BACKGROUND OF THE INVENTION

1. Field of the Invention

This invention relates generally to sports equipment. More particularly, it relates to an improved actively warmed outerwear.

2. Background of the Related Art

Ski poles and gloves are two essential items for skiers. To help retain control of a ski pole in the event of a crash or other fall, ski poles conventionally include either a restraining loop for placing an arm through before grabbing the grip of the ski pole (as depicted in FIG. 8A), or a circular grip through which a hand is placed (as depicted in FIG. 8B). When using the ski pole, one must utilize the restraining strap or other physically restraining device intended to keep the ski pole physically attached to the skiers hand during a crash or other fall.

There are many conventional devices commercially available to warm gloves/mittens, but these typically include the use of a single-use chemical heating pack, or the use of a battery pack and heating element enclosed within a relevant glove itself. But single-use chemical packs add bulk to gloves, and the heat they produce cannot be regulated. Moreover, self-enclosed battery-heating glove systems offer repeated uses and the ability to regulate heat, but each glove is encumbered by a battery which adds bulk and weight to that glove. To minimize the bulk and weight of a self-enclosed battery within a glove, the physical size of the battery is minimized, but this limits both the amount of heat that can be produced from such a battery pack as well as the length of useable time of the heating system before the battery must be replaced or recharged.

There is a need for an improved system and method for heating a hand of a skier.

### SUMMARY OF THE INVENTION

In accordance with the principles of the present invention, a ski pole for powering a heating element, comprises a battery carriage integrated into an upper portion of a ski pole. A ski pole grip comprises a first electrical connector for connection to the battery carriage. A second electrical connector is for connection with a heating element. The heating element is powered by the battery carriage in the ski pole.

In accordance with another aspect of the invention, a heated ski glove comprises a glove including an internal heating element. An integrated electrical strap is attached to the glove. The integrated electrical strap includes an electrical power cable. A plurality of electrical contacts are connected to the electrical power cable for connection to a grip of a ski pole.

In accordance with yet another aspect of the invention, a method of heating a ski glove comprises charging a battery contained within a ski pole. A heating element contained in a ski glove is electrically coupled to the battery contained within the ski pole.

### BRIEF DESCRIPTION OF THE DRAWINGS

Features and advantages of the present invention will become apparent to those skilled in the art from the following description with reference to the drawings:

FIG. 1 shows a heated glove/strap system and connectors in combination with the grip system mounted on a ski pole in accordance with one embodiment of the invention.

FIG. 2 shows an embodiment of a ski pole grip in relationship to the ski pole/battery assembly upon which it is mounted, in accordance with the principles of the present invention.

FIG. 3 shows an exemplary ski pole/battery system including a battery carriage seatable on the upper portion of a ski pole, in accordance with the principles of the present invention.

FIG. 4 shows an exemplary male and female electrical connection hardware system integrated into the glove/strap and pole/grip systems, in accordance with the principles of the present invention. FIG. 5 depicts an exemplary upper portion of a ski pole including threads to secure the power grip to an exemplary ski pole/battery system, in accordance with the principles of the present invention.

FIG. 6 shows various views of an exemplary power grip including cutaways showing how the exemplary hardware attaches to the grip, how electrical contacts are integrated into the grip, and how threads in the lower portion of the grip mate to the pole/battery system, in accordance with the principles of the present invention.

FIG. 7 shows an exemplary glove /strap/electrical system including an ON/OFF switch to control the flow of electricity to heating elements in the glove, and a hook-and-loop cover to protect the ON/OFF switch, in accordance with the principles of the present invention.

FIG. 8A shows an upper portion of a conventional ski pole including a grip having a restraining loop for placing an arm through before grabbing the grip of the ski pole.

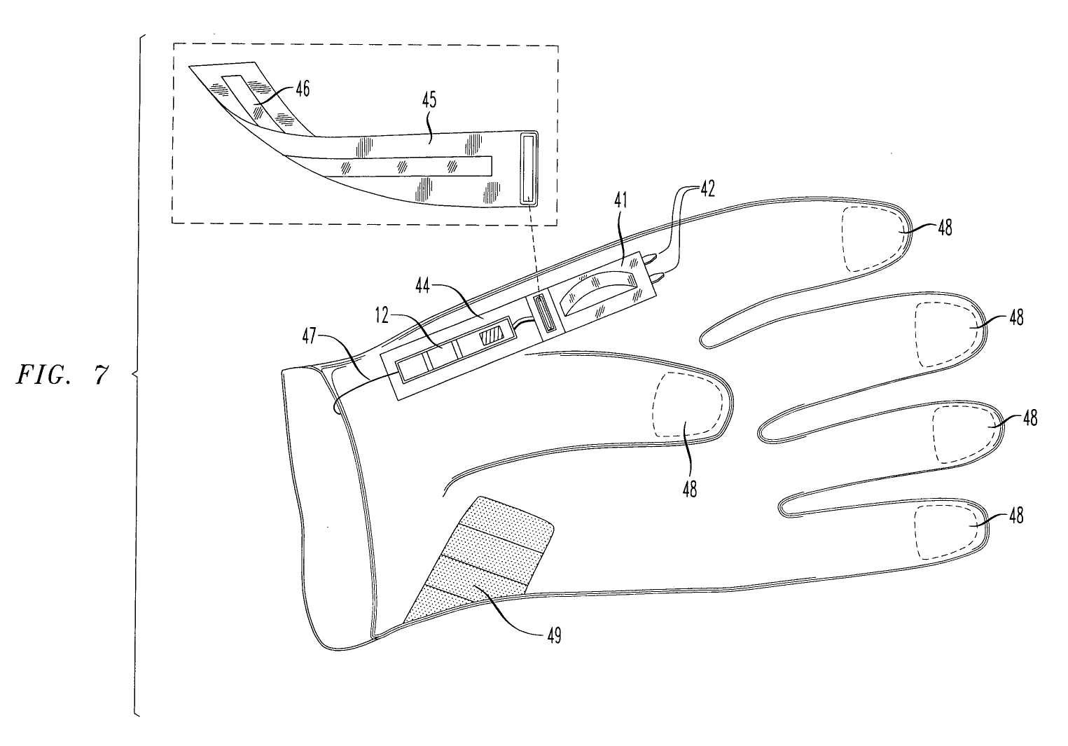

FIG. 8B shows an upper portion of a conventional ski pole including a grip having a circular grip through which a hand is placed.

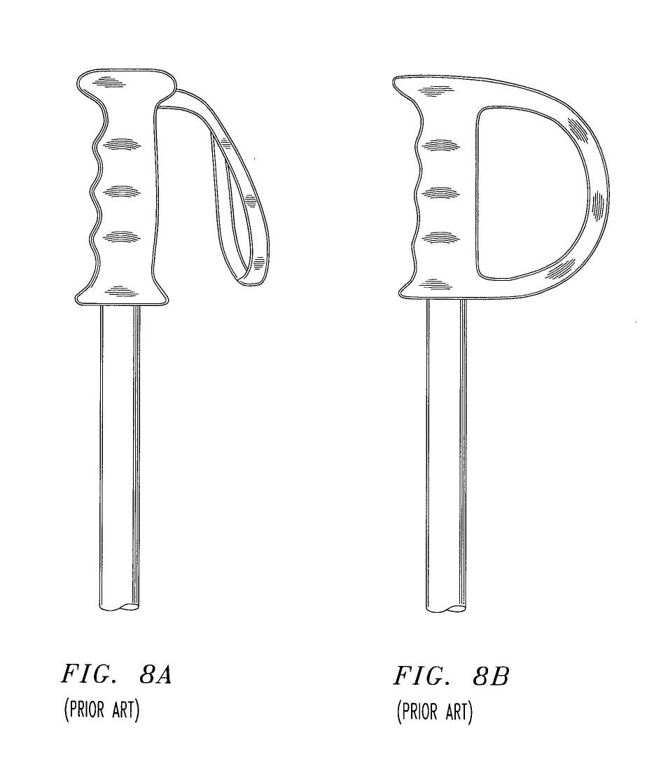

### DETAILED DESCRIPTION OF ILLUSTRATIVE EMBODIMENTS

This invention relates to a system comprising a ski pole that mates with a glove containing an electrically powered heating element therein. The ski pole contains a battery power source comprising one or preferably a plurality of battery cells. Generally speaking, the greater the number of battery cells the higher the voltage that can be applied to the heating element in the mating glove, ultimately providing a better balance between an amount of heat generated and a lifetime on a given battery pack or recharge.

The present invention implements a power cord into a strap attachment between the ski pole and a the glove of a skier, thereby electrically interconnecting a battery within the ski pole with a heating element in the outer wear of a skier (e.g., a heating element in the mating glove of the skier.)

In the disclosed embodiments, the ski pole connects electrically to a mating glove, e.g., via a releasable strap. The releasable strap may be integrated into either the ski pole and attached to the mating glove, or integrated into the glove and attached to the ski pole. In the described embodiments the releasable strap comprising a power cord is attached to the heated glove and releasably plugged into a matching connector on the ski pole.

This invention solves both problems by locating the battery in the pole instead of the gloves. The pole strap is, in one embodiment, integrated into the glove to form a single unit with a detachable connector to the pole grip, serving as a conduit for power flowing from the power source contained within the ski pole to one or more heating elements contained in the matching glove.

The bulk and weight of heated glove systems are a particular concern for ski racers who must wear a highly protective and sleek glove than can withstand high-speed impacts with the plastic gates typically used on race courses. Many ski racers sacrifice warmth in favor of protection and performance in racing gloves. This invention solves this problem for racers by providing the power source for a heating element in the ski pole. The system and method preserves glove protection and performance, while keeping the racers hands warmer than unheated gloves of similar design, size and weight.

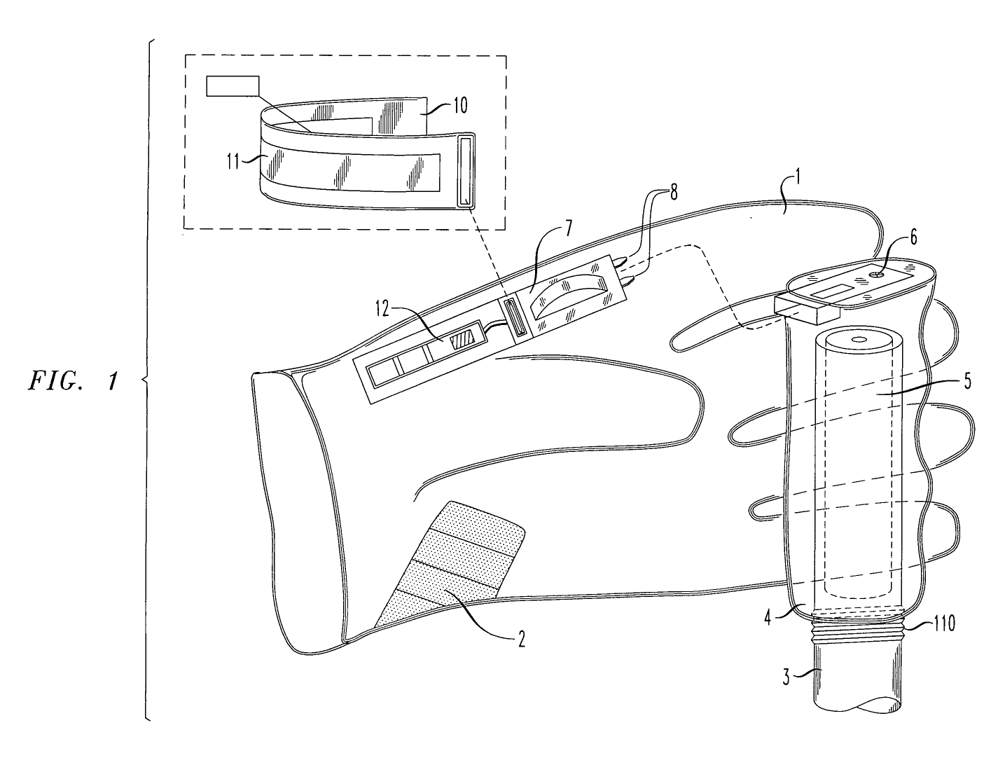

FIG. 1 shows a heated glove/strap system and connectors in combination with the grip system mounted on a ski pole in accordance with one embodiment of the invention.

In particular, in the embodiment of FIG. 1, a strap 10 comprising nylon webbing and an internal electrical heating element(s) 2 are directly stitched to a glove 1 to be worn by a skier. The strap 10 and electrical heating element 2 function as a single unit.

A battery and carriage assembly 5 are contained within a ski pole 3, e.g., preferably in the top portion of the ski pole 3 within the grip 4 on the tube of the ski pole 3.

The grip 4 (with female connector 6) affix to the pole/battery system, e.g., by threads 110 formed on the ski pole 3 and matching threads on the inside portion of the grip 4. Together the grip 3/connector 6 assembly and the ski pole 3/battery and carriage assembly 5 function as a single unit when inside the ski pole 3, though the battery(ies) may be inserted into the carriage assembly after the carriage assembly is mounted within the ski pole 3.

In use, to couple the glove 1 to the power supply of the ski pole 3, the strap 10 is manually connected to a suitable matching connector 7, e.g., a male connector made of, e.g., high density plastic with metallic positive and negative electrical contact points 8 joined to wires inside the connector 7 that conduct electricity through a heating element in the glove 1 via a switch 12.

The male connector 7 mates with a female connector 6 affixed in an appropriate location on the pole grip 4, e.g., using screws or other appropriate affixing technique (including forming within the grip 4). Positive and negative power contact points inside the female connector 6 conduct electricity from the battery pack 5 to the male connector 7. In a preferred embodiment the polarity of the contact points may be reversed with no affect on the performance of the heating system, though a polarized connector is within the principles of the present invention. Polarization may be provided mechanically in the design of the connectors 6, 7, and/or by the placement of both a male and female connector in each of the connectors 6, 7. A non-polarized connector system simplifies the process of reconnection by a skier in use (who may be covered in snow, wearing the gloves, standing precariously on a hill, etc.)

The strap 10 may include Velcro™ or other hook and loop material affixable over the switch 12 to allow protection of the switch 12 and prevent inadvertent ON or OFF operation. The strap 10 may include a flexible plastic window 11 attached to the male connector to serve both as a protective cover for the switch 12 as well as to permit viewing of the position of the switch 12 by the skier.

Once the strap 10 is attached to the pole/battery/grip assembly (and connectors 6, 7 are electrically coupled), the skier preferably may regulate the flow of electricity to appropriate electrical heating elements in the glove using an appropriate adjustable resistor, rheostat, thermostat, or other appropriate temperate-regulating device between the battery 5 and the heating element(s) 2.

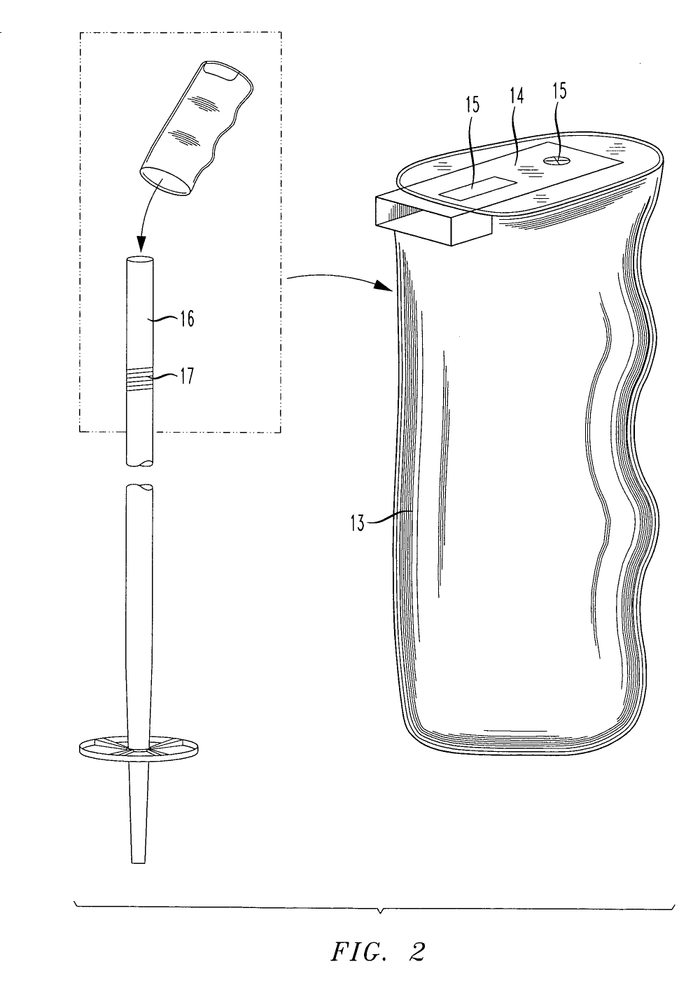

FIG. 2 shows an embodiment of a ski pole grip in relationship to the ski pole/battery assembly upon which it is mounted, in accordance with the principles of the present invention.

In particular, with reference to FIG. 2, a grip 13 including an appropriate power connector 14 assembly affixes to the ski pole 16 by turning clockwise on threads 17. The grip connector assembly 14 is affixed to the grip 13, e.g., using a pair of screws 15 that attach to the plastic material of the grip 13.

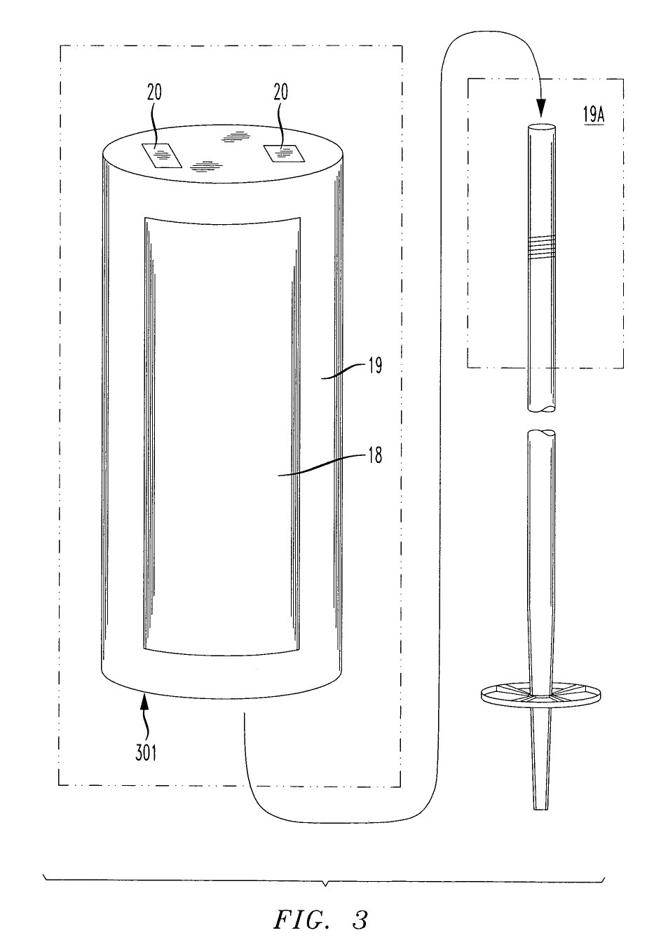

FIG. 3 shows an exemplary ski pole/battery system including a battery carriage seatable on the upper portion of a ski pole, in accordance with the principles of the present invention.

In particular, with reference to FIG. 3, a plastic battery carriage 19 containing positive and negative contact points accepts an appropriately sized battery, e.g., a type “AA” battery 18, to form a battery assembly 301. The battery assembly 301 has a positive contact point and a negative contact point (collectively referenced as 20 in FIG. 3) which match electrically to appropriate contact points in the female connector 6, 14 affixed to the grip 4, 13. The battery assembly 301 inserts into a space in the upper portion of the ski pole 3, 16 as shown in FIG. 3 at 19a.

In another embodiment, the battery carriage 301 may be moved in relation to a length of the ski pole to change a balance of the ski pole 3, 16. While the position of the battery carriage 301 is preferably set by the manufacturer at the factory, and preferably located in the uppermost portion of the ski pole 3, 16, in a more elaborate system the battery carriage may be moved to a custom placement by the user to permit a customized balance to the ski pole 3, 16. This customization may take place either at the retail store where the ski equipment is purchased or serviced, or at home by the customer. For instance, the battery carriage 301 may be sized within the internal void of the ski pole 3, 16 and permitted to slide up and down a given amount within the ski pole 3, 16. An opening may be formed in the battery carriage 301 to accept a securing pin or screw placed through an outer portion of the ski pole 3, 16 into the accepting opening of the battery carriage 301, thereby securing the battery carriage 301 at that point and preventing any additional sliding of the battery carriage 301 within the ski pole 3, 16.

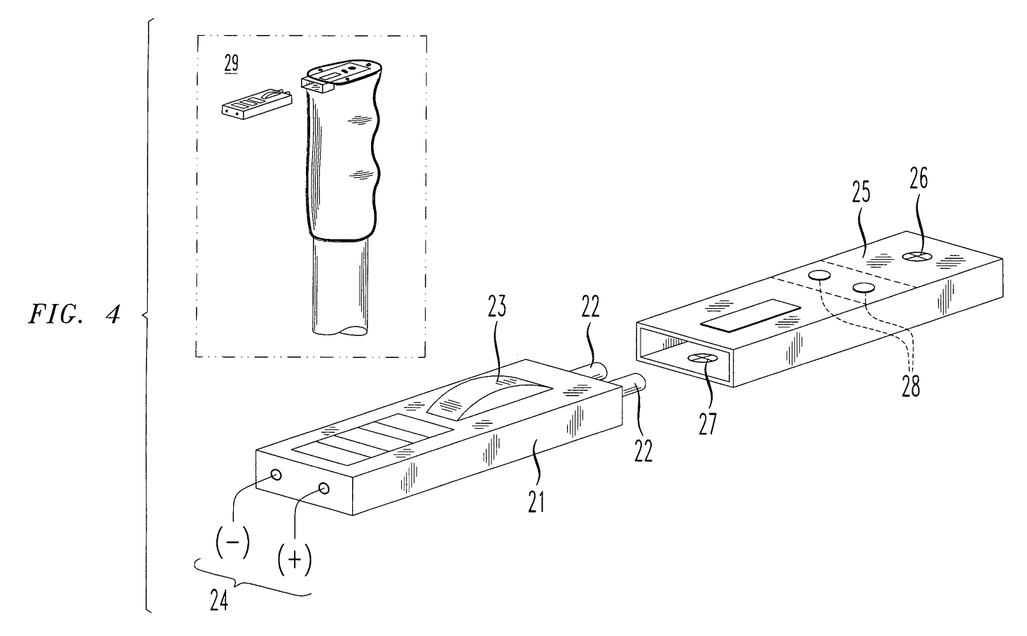

FIG. 4 shows an exemplary male and female electrical connection hardware system integrated into the glove/strap and pole/grip systems, in accordance with the principles of the present invention.

In particular, with reference to FIG. 4, the male connector 21 attached to the glove/strap unit has positive and negative contact points 22 to conduct electricity provided by the battery pack through the female connector 25. The contact points 22 are wired internally 24 to connect with the ON/OFF switch 12. In the disclosed embodiments, the connector 6, 14, 22 has a pair of screw holes 26, 27 permitting affixation of the connector 6, 14, 22 to the grip 4, 13.

Contact points inside the grip connector 28 connect to wires that conduct electricity from a metal plate inside the grip 4, 13. When the grip 4, 13 is attached to the heating element 2 of the ski glove 1, the plate is in contact with the battery/pole assembly inside the upper ski pole and electricity is conducted through the battery pack 5 shown in FIG. 1.

FIG. 5 depicts an exemplary upper portion of a ski pole including threads to secure the power grip to an exemplary ski pole/battery system, in accordance with the principles of the present invention.

In particular, with reference to FIG. 5, the ski pole 30 is machined with threads 31 that accept the grip assembly. A block inside the pole 32 assures the battery carriage assembly 19, 19a in FIG. 3 seat correctly inside the pole.

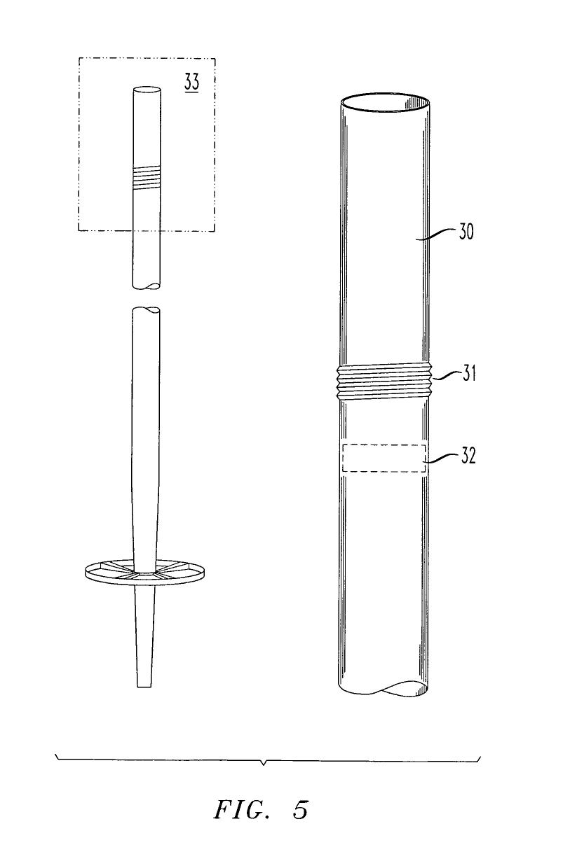

FIG. 6 shows various views of an exemplary power grip including cutaways showing how the exemplary hardware attaches to the grip, how electrical contacts are integrated into the grip, and how threads in the lower portion of the grip mate to the pole/battery system, in accordance with the principles of the present invention.

In particular, with reference to FIG. 6, the grip/female connector assembly 37 can be seen in cross-section where the female connector 40 affixes to the grip with screws 39. The female connector is wired to contact points 38 on a plate inside the grip 35a which mates with the battery assembly in the upper ski pole.

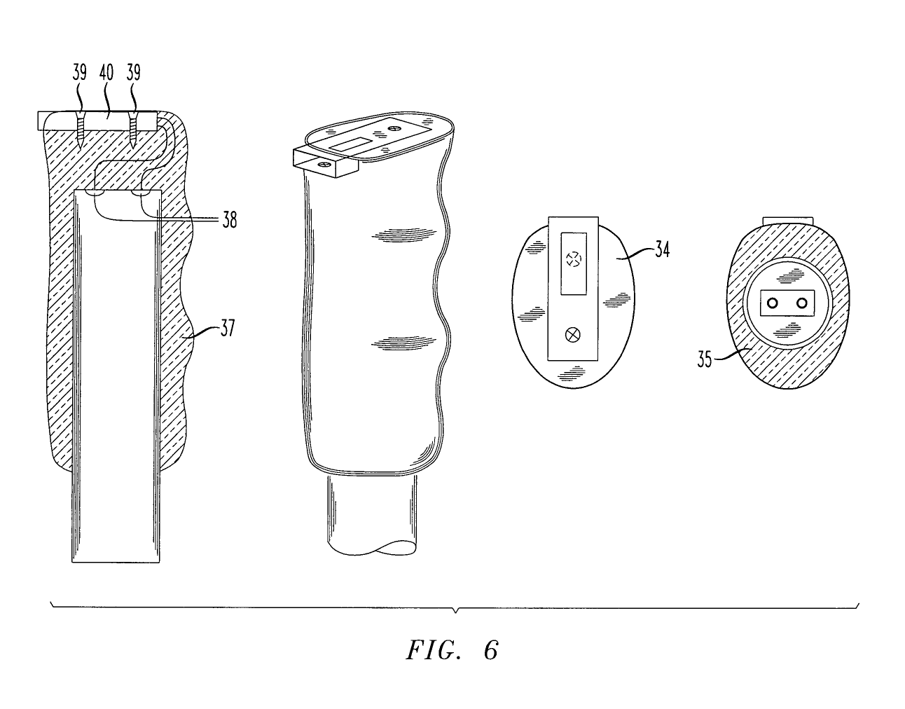

FIG. 7 shows an exemplary glove /strap/electrical system including an ON/OFF switch to control the flow of electricity to heating elements in the glove, and a hook-and-loop cover to protect the ON/OFF switch, in accordance with the principles of the present invention.

In particular, with reference to FIG. 7, electrical contacts 42 in the exemplary male connector are wired 41 to a variable resistor switch 43. From the switch, wires 47 connect to heating elements in the digits of the glove 48. The switch is protected by a Velcro type hook-and-loop fastened flap 45, including a viewing area window 46 to protect the position of the switch 43 yet permit viewing of the position of the switch 43. The flap 45 is affixed to a matching bar on the male connector.

The temperature of the heat in the glove may be adjusted by an appropriate rheostat or other known technologies for adjusting an amount of heat applied to an electrical heating element from a battery power supply.

While the invention has been described with reference to the exemplary embodiments thereof, those skilled in the art will be able to make various modifications to the described embodiments of the invention without departing from the true spirit and scope of the invention.

What is claimed is:

1. A ski pole for powering a heating element, said ski pole comprising:
a battery carriage integrated into an upper portion of a ski pole; and
a ski pole grip comprising a first electrical connector for connection to said battery carriage, and a second electrical connector for connection with a heating element;
wherein said heating element is powered by said battery carriage in said ski pole.

2. The ski pole according to claim 1, further comprising:
a rechargeable battery in said battery carriage.

3. The ski pole according to claim 1, wherein:
said heating element is worn by a skier wearing said glove.

4. The ski pole according to claim 3, wherein:
said heating element is integrated in said glove.

5. The ski pole according to claim 1, further comprising:
a strap secured to said ski pole, said strap including a power cable and a connector for mating with a glove of a user.

6. A heated ski glove, comprising:
a glove including an internal heating element;
an integrated electrical strap attached to said glove, said integrated electrical strap including an electrical power cable; and
a plurality of electrical contacts connected to said electrical power cable for connection to a grip of a ski pole.

7. The heated ski glove according to claim 6, wherein:
wherein said internal heating element extends into each of a plurality of digits of said glove.

8. The heated ski glove according to claim 6, wherein said electrical power cable consists of:
two electrical power leads.

9. The heated ski glove according to claim 6, wherein said electrical power cable consists of:
two electrical power leads; and
an electrical ground to electrically ground said ski pole to said glove.

10. The heated ski glove according to claim 6, wherein:
said plurality of electrical contacts connected to said electrical power cable form a male connector for mating with said grip of said ski pole.

11. A method of heating a ski glove, comprising:
charging a battery contained within a ski pole; and
electrically coupling a heating element contained in a ski glove to said battery contained within said ski pole.
